(19) United States
(12) Patent Application Publication
(10) Pub. No.: US 2018/0011306 A1
(43) Pub. Date: Jan. 11, 2018

(54) DUAL FREQUENCY AUTOFOCUS SYSTEM

(71) Applicant: Alakai Defense Systems, Inc., Largo, FL (US)

(72) Inventors: Robert Dean Babnick, Largo, FL (US); Adam J. Hopkins, Largo, FL (US); Nicholas M. Ventola, Largo, FL (US)

(21) Appl. No.: 15/639,915

(22) Filed: Jun. 30, 2017

Related U.S. Application Data
(60) Provisional application No. 62/358,305, filed on Jul. 5, 2016.

(51) Int. Cl. G02B 23/06; G01S 7/481; G01S 17/93; G02B 7/09

(52) U.S. Cl. CPC G02B 23/06; G02B 7/09; G01S 7/4816; G01S 17/936

(57) ABSTRACT

An apparatus, system, and method of focus compensation for a vehicle-mounted, downward looking optical detection system. A first stage compensator addresses high frequency events needing rapid, small displacement compensation. A second stage compensator addresses lower frequency but sometimes larger displacement compensation.

### CROSS-REFERENCE TO RELATED APPLICATIONS

This application claims the benefit of Provisional Application U.S. Ser. No. 62/358,305 filed on Jul. 5, 2016, all of which is herein incorporated by reference in its entirety.

### BACKGROUND OF THE INVENTION

### A. Field of the Invention

The present invention relates to optical detection systems such as can be mounted on vehicles and, in particular, to optical detection systems which require focusing on the target for effectiveness. In one example, the optical detection system is used for interrogation of the area in front of a vehicle.

### B. Problems in the Current State of the Art

There are several challenges associated with developing a vehicle-mounted, downward-looking optical detection system. The optical system will have to accommodate for target variability from factors that include, but are not limited to; ground undulation, rocks, bushes, patches of grass and other objects that will occur at various frequencies dependent upon the speed of the moving vehicle platform. In addition, the platform itself may have variability that occurs at low frequency or presents itself as nearly DC offsets to the optical focus control system. For example, a vehicle platform driving through thick grass will have tire contact at nearly ground level while the optical system will need to focus at the top of the grass surface where contamination may be deposited. This type of offset in focus range will present itself as a nearly constant DC offset to a focus control system. Additionally, from mission to mission, the payload of the platform may change (amount of fuel, number of personnel, gear, etc.) This payload variability will change the ride height of the optical platform. A conceptual graphic of an optical system 10 on a platform 16 mounted on bumper 14 of a vehicle 12 traveling over an undulating terrain 18 is shown in FIG. 1.

In an ideal world, a long stroke focus actuator could accommodate for both low and high frequency terrain and platform height variations. However, in practice, high frequency actuators such as voice coil actuators and piezo electrics have limited ranges of travel. Long stroke mechanisms that employ screw or belt drives are limited in frequency response.

Front-mounted downward looking optical sensors for military vehicles are known. See for example U.S. Pat. No. 6,838,671 issued to Northrup Grumman Corporation in 2005 (incorporated by reference herein) describes generally an infrared (IR) sensor array, which also may or may not include downward looking ground penetrating radar sensors. Further basic details, including a mounting platform and general operational aspects, can be seen.

A discussion of some optical downward looking land mine detection techniques are found at Cremer, et al. “Comparison of vehicle-mounted forward-looking polarimetric infrared and downward-looking infrared sensors for landmine detection”. Preprint Proc. SPIE Vol. 5089, Det. and Rem. Techn. for Mines and Minelike Targets VII, Orlando Fla., USA, April 2003 (incorporated by reference herein).

These systems include not only an optical sensor (e.g. imager), but also a digital processor programmed to identify things of interest captured by the sensor. In a moving vehicle, this requires fast processing to not only analyze the sensor data but then alert the vehicle personnel of identification of needed action. As can be appreciated, accuracy of the optical detection can be very dependent on the validity of the sensor data which, in turn, can be very dependent on whether the sensor is optically focused on the correct target. Typically, these systems include an autofocus system to promote that. However, as indicated above, there are times or situations were conventional autofocus subsystems are either too slow to keep up whether rapidly changing terrain or target positions, and times or situations that create offset of the optical sensor from an original or calibrated position. The latter can require substantial compensation but tend to occur less frequently.

Therefore, a need has been identified in this technical field. A need for effective compensation for an autofocus system for optical detectors of this type which handles both quick, small displacement adjustments while the vehicle is moving, as well as periodic, as-needed but larger displacement adjustments such as when the target at a different height than the ground or road or the vehicle ride-height changes because of such things as loading (people or supplies). Effectiveness can include not only ability to handle this variety of adjustments in a timely fashion, but also promote more accuracy in the optical sensing in sometimes challenging environmental conditions and data processing requirements. Attempts at focusing compensation have been made in other technical areas.

For example, in photolithography, where focus is very important, U.S. Pat. No. 4,435,055 addresses it as follows. U.S. Pat. No. 4,435,055 is a very close range dual frequency focusing mechanism using ultrasonic ranging. Details can be found at U.S. Pat. No. 4,435,055, incorporated by reference herein. This would require additional components and complications if added to the typical downward looking optical detection systems discussed above. The dual frequency refers to using ultrasound at different frequencies to distinguish them as measurement signals, not with respect to time and number of needed focusing compensation events.

In the context of a regular camera, U.S. Pat. No. 5,136,324 describes an autofocus camera zoom lens system that uses two motors for coarse and fine focus control. Details can be found at U.S. Pat. No. 5,136,324, incorporated by reference herein. This type of use of motors may not be quick enough for high frequency focusing compensation such as needed with the present invention.

Therefore, there is a need in this technical art for a solution to focusing compensation for both high frequency, small displacement adjustments but also less frequent, larger displacement adjustments for on-board optical sensing and detection systems.

### SUMMARY OF THE INVENTION

To address both of these challenges, we propose employing a dual frequency band, dual stage auto-focus mechanism. One stage would use a limited stroke actuator to move either the secondary or primary mirror of the telescope to accommodate for high frequency terrain/platform variations. A second stage would be employed to either (1) move the primary or secondary telescope mirror, or (2) move the entire telescope and optical mechanism within the sensor package with respect to the vehicle platform. A conceptual block diagram of the dual stage control system is shown below.

### BRIEF DESCRIPTION OF THE DRAWINGS AND APPENDICES

A. Drawings

FIG. 1 is a diagrammatic view of one exemplary embodiment of the invention mounted on a military vehicle.

FIG. 2A is a side elevation view of basic components of an optical detection system used in the exemplary embodiment of FIG. 1.

FIG. 2B is a perspective view of the optical detection system of FIG. 2A.

FIG. 3 is a diagrammatic and functional view of major components of the exemplary embodiment of FIGS. 1 and 2A-B.

FIG. 4 is a graph illustrating one example of measured high frequency changes in road height for a vehicle traveling on the road.

B. Background Information (each incorporated by reference herein)
U.S. Pat. No. 6,838,671 (Northrup Grumman Corp.)
Cremer, et al. “Comparison of vehicle-mounted forward-looking polarimetric infrared and downward-looking infrared sensors for landmine detection”. Preprint Proc. SPIE Vol. 5089, Det. and Rem. Techn. for Mines and Minelike Targets VII, Orlando Fla., USA, April 2003)
U.S. Pat. No. 4,435,055
U.S. Pat. No. 5,136,324
Acuity Laser AccuRange AR-2500 laser range finder info https://www.acuitylaser.com/products/item/ar2500-laser-sensorEquipment Solutions, Inc. LFA-2010 linear focus actuator info http://www.motionshop.com/pr/EquipSol-LFA-2010-Animation.shtml
Newport Optical mounts https://www.newport.com/c/optical-mounts Equipment Solutions, Inc. SCA-814 servo controlled amplifier info http://www.equipsolutions.com/products/servo-controlled-amplifiers/sca814-servo-controlled-amplifier
ATS100-100 low frequency motion stage info https://www.aerotech.com/product-catalog/stages/linear-stage/ats100.aspx?search-auto-complete=true
VersaLogic Corporation VL-EPM3-30 focus control processor info https://versalogic.com/Products/PDF/DS-EPMe-30-Bengal.pdf
Kao, B. G. and Artz, B. Using road surface measurements for real time driving simulation. Proceedings of the 1^{st} Human-centered transportation simulation conference. University of Iowa, Iowa City, Iowa. Nov. 4-7, 2001, https://www.nads-sc.uiowa.edu/dscna/2001/Papers/Kao_Using%20Road%20Surface%20 Measurements . . . pdf
Xu, Da-Ming and Yong, R. N. Autocorrelation Model of Road Roughness. Journal of Terramechanics, Vol. 30, no. 4, pp. 259-274, 1993.

### DETAILED DESCRIPTION OF EXEMPLARY EMBODIMENTS OF THE INVENTION

### A. Overview

For a better understanding of the invention, detailed descriptions of several embodiments it can take will now be described. The examples will be discussed primarily in the context of a downward looking optical detection system for military applications and vehicles such as sensing of terrain, presences of unwanted objects, or the like. It is to be understood, however, that the invention is not necessarily limited to such applications and the embodiments below are neither inclusive nor exclusive of all the forms and embodiments the invention can take.

Further, the examples discuss an over-the-ground wheeled military vehicle such that can attain ground speeds over a wide range (e.g. 0 to 100 kph or more) and carries the optical detection system on a platform mounted at the front of the vehicle (see, e.g., U.S. Pat. No. 6,838,671 and Cremer, et al.). Variations from this are, of course possible.

Furthermore, certain components are electrically powered, which in the examples could come from the vehicle's electrical system or a separate portable on-board system.

### B. Exemplary Embodiment 1

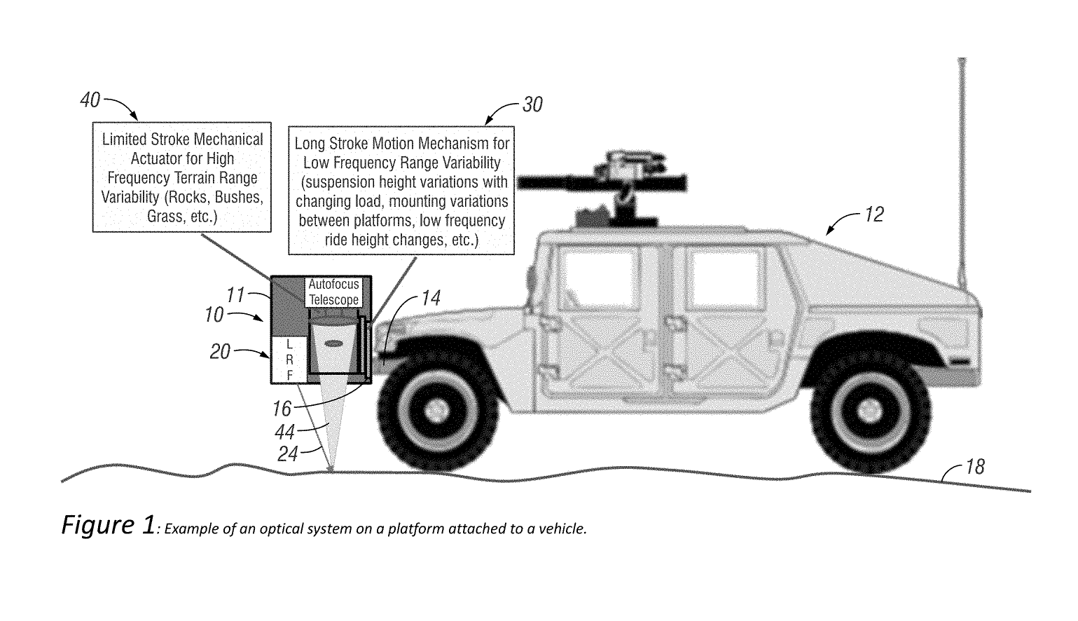

By reference to FIGS. 1-3, a first embodiment according to aspects of the invention will be described. As shown in FIG. 1, the embodiment is an optical detection apparatus/system 10 mounted to the front 14 of a military vehicle 12.

1. How to Make the Apparatus

With particular reference to FIGS. 1, 2A, 2B, and 3, a first embodiment is shown. The basic components are:

a) Vehicle:

Shown in FIG. 1 is a high mobility multipurpose wheeled vehicle 12 (one non-limiting example is a HMMWV) (see also, U.S. Pat. No. 6,838,671 and Cremer, et al.). Of course, others are possible.

b) Platform:

This carrier or base 16 (see diagrammatic depiction in FIG. 1) can be of a variety of designs sufficient to support the load of the components of the optical detection system 10 and mount to vehicle 12. For example, a non-limiting example is a steel shelf with steel arms fixed to the front bumper 14 or other structural components of the vehicle 10 (see also, U.S. Pat. No. 6,838,671 and Cremer, et al.).

c) Optical Detection System:

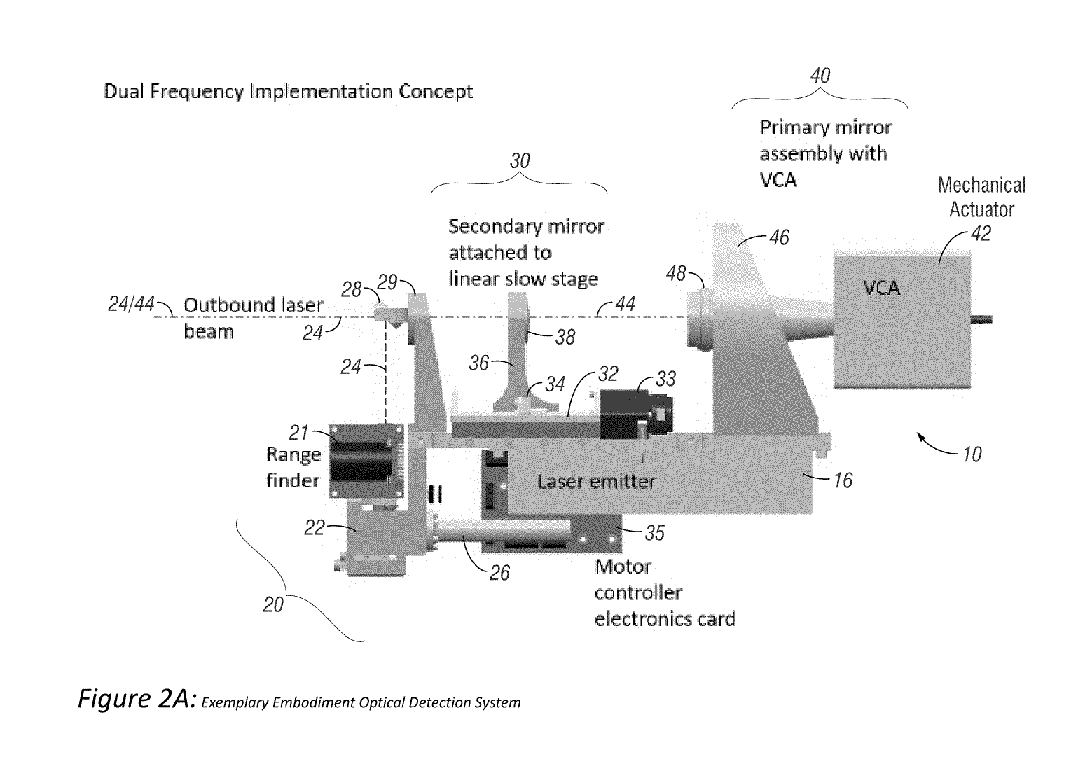

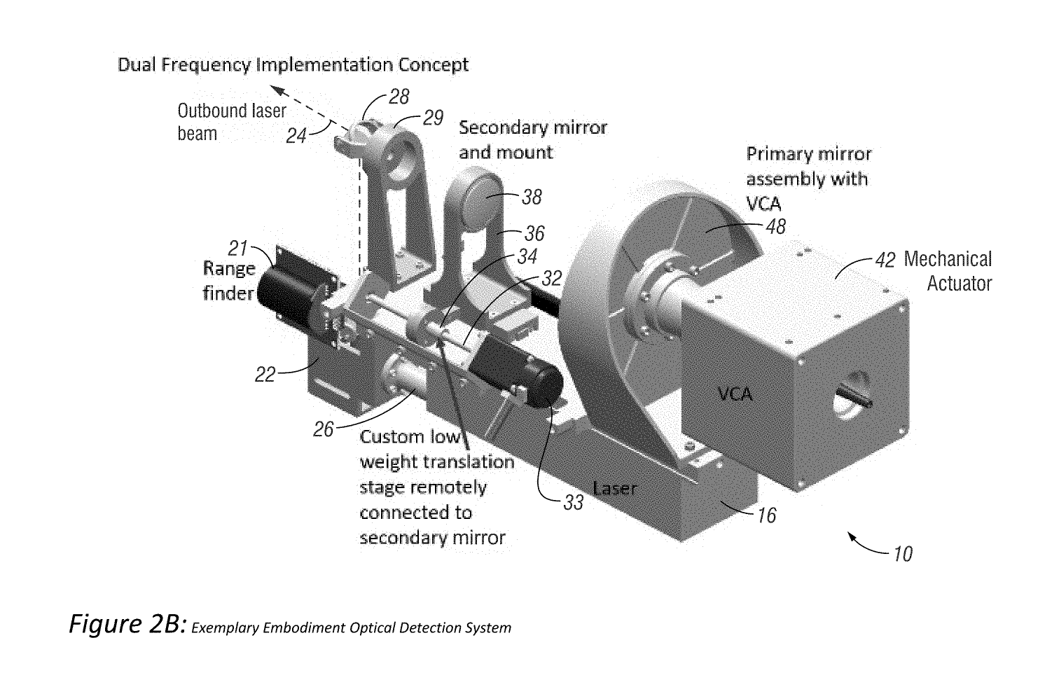

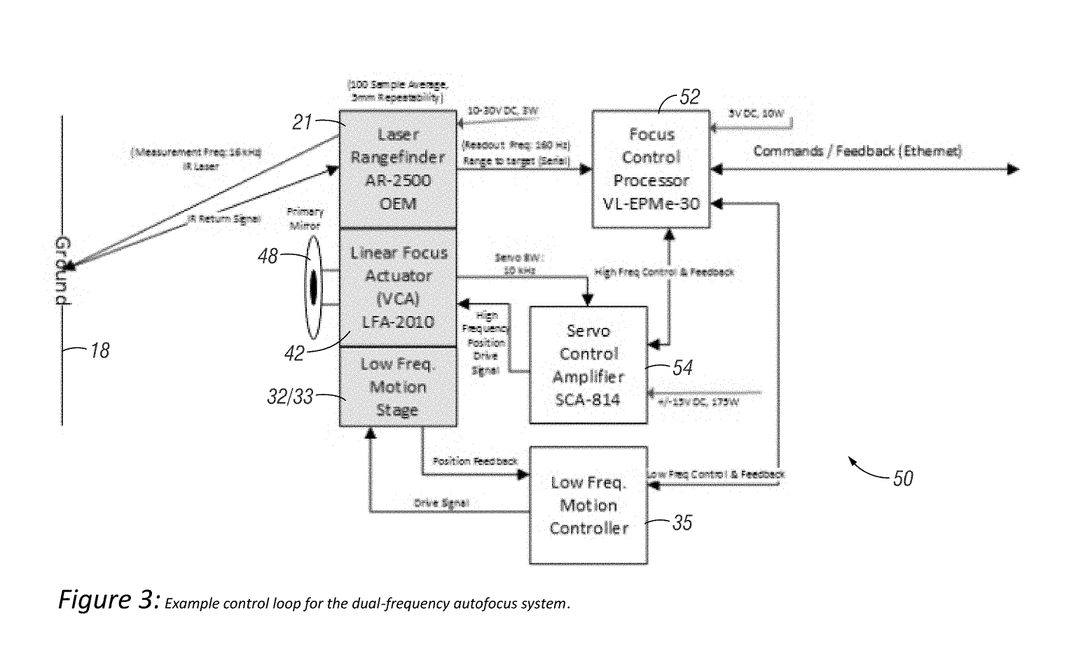

Typically, in a housing 11 (shown diagrammatically in FIG. 1 but not shown in FIGS. 2A-B), the optical detection system 10 is shown in detail in FIGS. 2A, 2B, and 3. Here it includes a system that must be focused to a target at the ground in front of the vehicle (typical distances are roughly on the order of a meter or two, but could be less or more). The challenges include varying terrain, varying target height relative to ground, changes in vehicle relationship to ground, etc. See, e.g., U.S. Pat. No. 6,838,671 and Cremer, et al.).

As shown in FIGS. 1, 2A and 2B, this embodiment uses a custom-built autofocus telescope having an optical axis 44 and field of view pointed at least substantially directly downward to terrain 18. A primary optic or mirror 48 and a secondary optic or mirror 38 are along that optical axis 44.

As shown in FIG. 2A and 2B, in this embodiment, the primary mirror 48 is mounted in a primary mirror assembly 46 that is fixedly mounted to base member 16. On the other hand, a secondary mirror mount 36 is slideable over a distance parallel to optical axis 44 on a boss or carriage 34 on linear stage 32 on base 16. This adjustability allows for change in spacing of primary 48 to secondary 38 mirror along the optical axis.

In this embodiment, the telescope shares optical axis 44 with laser beam 24 (outbound laser beam shown in FIG. 2A and B) emitted by a laser source 26 on base 16. The telescope receives backscattered light from laser 24 that may be used to identify materials on the ground.

d) Range Finder:

As indicated in FIGS. 2A, 2B, and 3, a laser range-finder (LRF) 21 is configured to have a field of view that overlaps with optical axis 44 of the telescope. This allows system 10 to estimate with substantial accuracy, and at a relatively high, continuous rate, distance from optical detector in the LRF to whatever laser 24 reflects from (e.g. ground, object, etc.). One non-limiting example of an LRF is an AccuRange AR-2500 commercially available from Acuity Laser of Portland, Oreg. (USA) (see incorporated by reference Acuity Laser AccuRange AR-2500 laser range finder info https://www.acuitylaser.com/products/item/ar2500-laser-sensor, for more details). Its components would be operably configured as shown in FIGS. 2A and 2B. An appropriate power source (not shown) would be connected.

e) Limited Motion Mechanical Actuator (e.g. Voicecoil Actuator (VCA)):

In one embodiment, the first stage focusing compensation 40, for high frequency events, uses a voice coil actuator (VCA) 42 (see FIGS. 2A, 2B, and 3) mounted to primary mirror assembly 46. Such a device, here, as one non-limiting example, model LFA-2010 commercially available from Equipment Solutions of Sunnyvale, Calif. (USA) (see Equipment Solutions, Inc. LFA-2010 linear focus actuator info http://www.motionshop.com/pr/EquipSol-LFA-2010-Animation.shtml incorporated by reference, for more details), would be operably connected to the primary lens or mirror of the telescope. Alternatively, it could be operably connected to the secondary lens or mirror. As indicated in the Equipment Solutions, Inc. LFA-2010 linear focus actuator information http://www.motionshop.com/pr/EquipSol-LFA-2010-Animation.shtml, this component can cause linear displacement or movement of the optic or mirror along the optical axis from a home position towards or away from the other optic or mirror over a limited range but very quickly and repeated with high accuracy. This would allow quick and repeated focus adjustment.

One way to interface the VCA with the lens or mirror is by placing the lens or mirror in an optical mount (see, e.g., www.newport.com/c/optical-mounts) which is then operably connected to the linearly movable component of the VCA. (See Newport Optical mounts https://www.newport.com/c/optical-mounts, incorporated by reference, for more details). As indicated in FIG. 3, the VCA could be instructed as to time and amount of movement via a servo controlled amplifier 54 like model SCA-814 from Equipment Solutions, Portland, Oreg. (USA) (one non-limiting example is Equipment Solutions, Inc. SCA-814 servo controlled amplifier info http://www.equipsolutions.com/products/servo-controlled-amplifiers/sca814-servo-controlled-amplifier, incorporated by reference, for more details).

The term “voice coil” as used herein has been generalized and refers to any galvanometer-like mechanism that uses a solenoid to move an object back-and-forth within a magnetic field. It is commonly used to refer to the coil of wire that moves the read-write heads in a moving-head disk drive. In that application, a very lightweight coil of wires is mounted within a strong magnetic field produced by permanent rare-earth magnets. The voice coil is the motor part of the servo system that positions the heads: an electric control signal drives the voice coil and the resulting force quickly and accurately positions the heads. Therefore, it can respond quickly and accurately for relatively small linear displacements such as here. Like a voice coil which drives a speaker cone or element, the VCA can rapidly move the mirror fore or aft along the optic axis for relatively small distances. A typical rough range of distances for this embodiment is typically sub-millimeter but could be in the approximate range of on the order of 0 to 20 mm. Like a speaker cone, the driven mirror can follow driving signal that can vary rapidly in length and amplitude. This can be based on feedback from the LRF, which also can measure telescope to target distances rapidly and continuously. The response times from the VCA are as discussed in Equipment Solutions, Inc. SCA-814 servo controlled amplifier information, https://www.newport.com/c/optical-mounts and http://www.equipsolutions.com/products/servo-controlled-amplifiers/sca814-servo-controlled-amplifier.

This provides the high frequency autofocusing stage 40. It can adjust the mirror at such high frequencies (e.g. on the order of 10-100 hz (˜100 to 1000 ms) to relatively high accuracy because of it relatively short stroke or range of movement.

Other types of limited stroke actuators are possible. For example, the U-521/M-663 Miniature linear stage from PI motion. http://www.pi-usa.us/products/Piezo_Motors_Stages/Linear-Motor-Precision-Positioning.php#M663 Piezo motors provide short stroke, high speed positioning much like a VCA or galvo.

f) Long Stroke Actuator (LSA):

The second stage focus compensator 30 can be any of a variety of linear actuators that has a range of movement sufficient for present purposes. Such a device can take different forms.

Its basic function is to provide compensation for less frequent events that can affect focusing. By less frequent it is meant less frequent than the sometimes very frequent and rapid distance changes between target and optical sensor caused by such things as terrain undulations experienced when going several tens of kilometers per hour. This compensation does not have to be correspondingly rapid to terrain undulations at speed, so it does not require a rapid response component such as the VCA discussed above. Also, since the less frequent events may cause more offset than the high frequency events, or at least at constant larger offset, a compensator with longer range of travel is indicated than a typical VCA.

Because the first stage compensator in this embodiment is dedicated to the primary optic of the telescope, the second stage must move something else.

In this embodiment, and as shown at FIGS. 2A and 2B, the second stage compensator 30 is a custom low weight translation stage 32 mounted to base 16 of the overall assembly. It has a very accurately controllable motor 33 that rotates a lead screw on which a lead nut or carriage 34 is placed. The lead nut 34 moves fore or aft depending on amount and direction of rotation of the lead screw. The lead nut 34 is connected to secondary mirror mount 36. Therefore, amount and direction of movement of the lead screw causes a proportional fore or aft sliding of secondary mirror mount 36 (and thus secondary mirror 38) along optical axis 44. It can be seen that the actuator motor 33 is remote in the sense it is away from the optical axis and requires a mechanical linkage to effect mirror movement.

In one form translation stage 32 is a linear actuator that does not need to operate quickly but needs a longer range of motion than VCA 42. One non-limiting example of such actuator can be model ATS100-100 from Aerotech (see ATS100-100 low frequency motion stage info https://www.aerotech.com/product-catalog/stages/linear-stage/ats100.aspx?search-auto-complete=true incorporated by reference, for more details). It can take instructions from an intermediary control, like the VCA, but as shown in FIG. 3 can be instructed directly from a programmable controller or processor (e.g. focus control processor 52, see FIG. 3). A variety of linear actuators or stages are possible for low frequency event compensation.

In this embodiment, a typical range of movement of second mirror 38 would be on the order of between 0 mm and 100 mm. It is called a low frequency stage because it is typically used less frequently (e.g. much less frequently than the VCA, perhaps only a few times per hour, perhaps sometimes only 1 time per day, if at all each day) or at a much lower frequency (e.g. on the order of 1 to 10 Hz or more). And because the adjustment is less frequent, it is usually sufficient that it by a different actuator. The overall time for adjustment can be longer also because it may involve a much longer fore or aft movement.

Again, one source for determining when and how much movement for secondary mirror 38 can come from LRF 21. Other sensors or inputs can also be used.

g) Focus Control Processor:

As shown in FIG. 3, this embodiment uses model VL-EPMe-30 processor 52 from VersaLogic Corporation, Tualatin, Oreg. (USA) (see VersaLogic Corporation VL-EPMe-30 focus control processor info, https://versalogic.com/Products/PDF/DS-EPMe-30-Bengal.pdf, incorporated by reference, for more details) to not only instruct operation of both first and second stage linear actuators, but receive output from the laser rangefinder and any input from other systems. It would be programmed to determine when and how much fine displacement by the VCA is needed, and instruct it to happen; and when and how much gross displacement by the low frequency motion controller 35 is needed, and instruct it. Some details about the nature of the signals between components can be seen in FIG. 3.

2. How to Use the Apparatus

In the overall implementation, laser range finder 21 samples the distance between the optical platform 16 and the ground 18 (target) at a much higher frequency than any of the mechanical mechanisms can respond. The terrain 18 heights are sampled with an accuracy/repeatability that falls within the depth of field of the optical collection system. The optical depth of field provides a hysteresis band for very high frequency target variability that cannot be accommodated for with either of the mechanical control mechanisms. These features occur with frequencies greater than 100 Hz and have sub-millimeter amplitudes in FIG. 3. The output of laser range finder 21 is fed into focus control processor 52. The focus control processor determines which stage should be moved and sends a focus command to the appropriate focus mechanism.

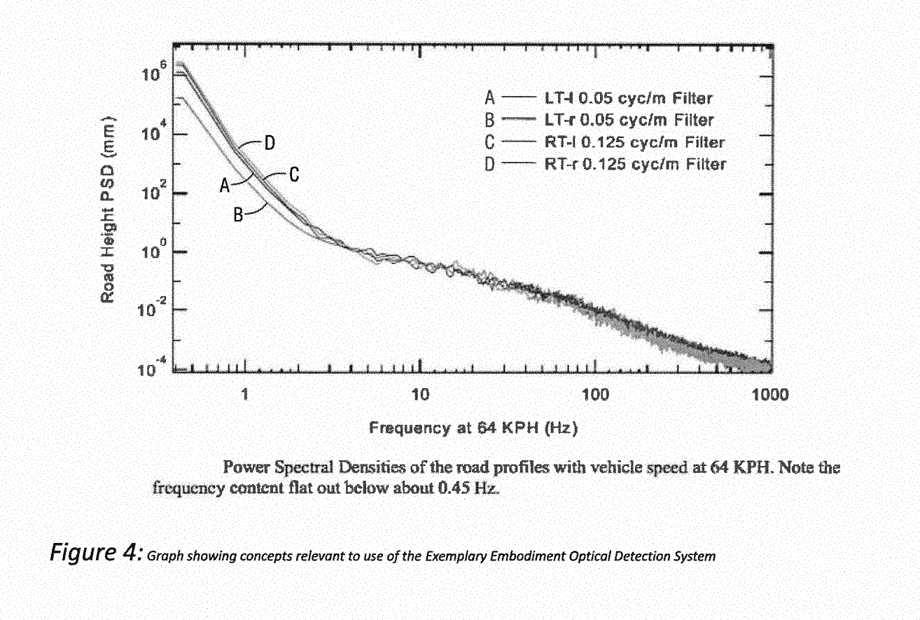

As will be appreciated by those skilled in the art, the components of the apparatus allow the following:
1) Using some type of feedback or sensed measurement to inform processor 52 of a low frequency event.
   a) For example, LRF 21 can inform processor 52 if starting ground to platform distance has changed from a reference distance. If so, processor 52 can instruct operation of the second stage linear actuator 32 to move to compensate for that change. The LRF 21 can report to processor 52 when sufficient linear movement for compensation has occurred, and processor 52 can then stop second stage actuator 32.
   b) Other ways to inform processor 52 of a low frequency event are possible. For example, a load sensor on vehicle 12 could inform of a sensed change in load of the vehicle. With calibration, that change in load could map to a certain linear movement by second stage actuator 32. Another example could include placing an encoder on the vehicle suspension system to measure the displacement and calculate the ground distance. Another example could include using an ultrasonic rangefinder to measure the ground distance from a large area and use this to inform the LSA.
2) Using some type of feedback or sensed measurement to inform the processor of a high frequency event.
   a) For example, LRF 21 can also inform processor 52 of high frequency events which rapidly change distance of target 18 from platform 16, and processor 52 change instruct operation of first stage linear actuator 42 to move to compensate for that change. As can be appreciated, sensing high frequency events presents many challenges. They must be sensed, recognized, and acted upon in almost real time. At higher vehicle speeds, this can be difficult.
   b) Therefore, an alternative is to utilize powerful mathematically-based algorithms or techniques to help processor 52 determine when and how much to operate first stage actuator 42.
      i) One example is illustrated at FIG. 4. Using power spectral density analysis, processor 52 could make decisions such as whether LRF 21 is seeing a low or a high frequency event, and thus, determine whether to actuate the first or second stage actuator for focus compensation.
      ii) In another example, processor 52 can simply try to operate first stage linear actuator 42 to match, as best it can, sensed high frequency events as they happen. Fast acquisition of data about each high frequency event, coupled with fast processing and implementation of an adjustment through servo control amp 54 (non-limiting example is SCA-814) and execution of proportional linear movement by VCA 42 can be effective due to operational capabilities of the components would be relied upon. Present capabilities are on the 100 Hz or 1-100 ms time scale to do so. Therefore, this would provide reasonable responsive focus compensation, even for quite high frequency events.
      iii) Another example is illustrated at FIG. 4. Using power spectral density analysis, processor 52 could decide from a variety of stored profiles which one to follow to operate first stage actuator 42. In other words, LRF 21 is sensing high frequency events that match one profile, processor 52 can assume correlated operation of first stage actuator 42 will provide effective focus compensation.
      iv) Another technique would use concepts from other technical areas to operate the system. These will be discussed below.

3. Road Surface or Roughness Measurement Techniques

Substantial work has been done trying to model, predict, or quantify road roughness for such things as driving simulation or road classification. Such models take into account vehicle parameters as well as variable vehicle contents (e.g. passengers or load).

Two examples of such studies can be found at:
Kao, B. G. and Artz, B. Using road surface measurements for real time driving simulation. Proceedings of the Pt Human-centered transportation simulation conference. University of Iowa, Iowa City, Iowa. Nov. 4-7, 2001
Xu, Da-Ming and Yong, R. N. Autocorrelation Model of Road Roughness. Journal of Terramechanics, Vol 30, no. 4, pp. 259-274, 1993.

Both are incorporated by reference herein and include discussion of use of power spectral density concepts.

The autocorrelation paper [Xu et al., supra] describes in detail how road roughness is described and the mathematical basis by which one would build a power spectral distribution (PSD) for tuning the device. In this type of analysis for vehicular travel on or off road, the PSD instructs the operator and or designer what ground distance variations occur with a given frequency. For example, in FIG. 4, variations in road height of less than 0.1 mm occurred with frequencies greater than 30 Hz. Variations from 0.1 to 100 mm occur with frequencies between 2 and 30 Hz. Variation events of greater than 100 mm occur less than 2 times per second.

Such techniques could be used to both help processor 52 distinguish between low and high frequency events (and thus determine whether to use the second or first stage actuator for compensation), but also to model, predict, or otherwise establish how it would instruct operation of the high frequency first stage actuator compensation.

Knowledge of representative ground height variations PSD for different surface conditions allow the invention to be configured with suitable high and low pass electronic filters for determining if a change in ground height can be responded to, and if so whether it should be accomplished by the VCA or the LSA. Such electronic filters are well-known to those skilled in the art. They can be hardware or software or a combination. They would analyze the real-time sensed ground height and compare it relative to thresholds or references. This comparison and switching between the VCA and LSA can be very rapidly by the processor or other component. Essentially, the system can store previously obtained PSD data for different road or surface conditions and basically use data for different conditions as calibration references for present sensed conditions. The processor memory (or other accessible data storage) can determine which calibration reference is most relevant to present sensed conditions, and then instruct VCA and LSA accordingly. This essentially would be selecting an approximation of what type of VCA and LSA actions are desired based on that a priori data. Even though it may not exactly match the actual road conditions, by using the PSD technique, it can help better keep the telescope focused and thus promote improved detection results. Such previously obtained reference ground or road condition data could be obtained from elsewhere (such as from published works, testing facilitates, or other), or the system could develop its own database of terrain variations based on its own operations. One application of this technique by the designer of the system is to generate pre-set configurations for where the motors of the linear actuators should try and hold their frequency response to. This sets the expected range variations allowed to be handled by each motor.

In a live operation of the invention, open power spectral analysis may be used to keep a running history of the terrain variation. Such a history can be used to dynamically change the responsiveness of the LSA and VCA so that the systems are not overtaxed by trying to accommodate large variations in range at speeds that will damage the motors. This tuning of dynamic range based on system operation can benefit not only improved detection results but also reduce wear and tear on components. One application of this technique of PSD analysis in operation as a historical measure of terrain variation, is to use it to set the Fourier frequencies for filtering between events that are of very high frequency and should not be adjusted for, events that are of high frequency and are within the range of motion of the VCA, and low frequency events, such as ground undulations.

### C. Exemplary Embodiment 2

In one implementation, the high frequency mechanism such as a linear focus voice coil actuator is connected to either the primary or secondary telescope optics. This mechanism provides the ability to focus on rapidly changing features with small variations in height. These features are represented by the data from approximately 10 to 100 Hz in FIG. 4. The long stroke mechanism is attached to the entire optical assembly and provides a linear offset to the system by moving the assembly in response to changes in the vehicle. For example, the sensor payload is on a vehicle one day with a ground to sensor distance of 1 m and calibrated for this range. On the second day, the vehicle conditions are different and the sensor to ground distance is 1.05 m. The long-stroke mechanism will shift the entire optical assembly automatically to accommodate the 5cm change in ground to sensor distance on sensor startup.

### D. Exemplary Embodiment 3

In another implementation, the high frequency mechanism such as a linear focus voice coil actuator is connected to either the primary or secondary telescope optic. The low-frequency, long-stroke mechanism is directly attached to the high-frequency mechanism. In this approach, the long-stroke mechanism can correct for offsets due to changes in vehicle configuration. It may also provide low frequency responses (<10 Hz) to undulations in the terrain as the vehicle is in motion. The high frequency response (≈10-100 Hz) to the presence of rocks or other debris is given by the high-frequency mechanism. In this implementation, the overall focus range of the telescope is increased.

### E. Exemplary Embodiment 4

In another implementation, the high frequency mechanism such as a linear focus voice coil actuator is connected to either the primary or secondary telescope optic. The low-frequency, long-stroke mechanism is attached to the other telescope optic. Both optics may be moved simultaneously so that the voice coil actuator compensates for small, rapid variations in terrain; and that the long-stroke stage drives the other mirror to compensate for undulations in the terrain or offsets arising from vehicle configuration changes.

These last two implementations prevent the linear focus voice coil actuator, for example, with short stroke from becoming biased toward one end of its travel range, limiting its ability to compensate for high frequency focus changes. The focus control processor ensures that the low frequency motion stage is in a position that keeps the voice coil actuator at its center of travel where it is most optimized to deal with high frequency motion.

### F. Exemplary Embodiment 5

Shown diagrammatically in FIG. 1, in this embodiment, it is operably connected to the entire optical assembly (e.g. the entire telescope). Its function is to move the entire telescope along the telescope's optical axis to compensate for any offset due to such things as the vehicle being weight down (and its suspension compressed) which would alter the distance between the telescope and prospective targets.

Thus, the first stage would give rapid, small displacement focus compensation. The second stage would give less frequent and larger displacement compensation.

As is described with respect to other embodiments, it is to be understood the second stage can interface with other components of the optical detector to provide its compensation. For example, alternatively it could be operable connected to the other of the primary or secondary optic not connected to the VCA and operate to linearly displace it relative the optic associated with the VCA. Theoretically, it could be placed between the platform and the connection of the platform and the vehicle.

### G. Options and Alternatives

As can be appreciated by those skilled in this technical art, variations to the foregoing examples are possible. Such variations obvious to those skilled in the art will be included within the invention, which is not limited by the specific embodiments above.

What is claimed is:

1. A downward looking optical detection system for mounting on a vehicle comprising:
a. a platform mounted on a vehicle;
b. an optical sensor mounted on the platform, the optical sensor comprising:
i. a telescope with a primary and a secondary optic along an optical axis pointed to the ground;
c. a range finder to provide distance between the platform and a target.
d. a first means to adjust one of the primary and secondary optic along the optical axis relatively frequently and for relatively short distances in response to relatively short in duration and small distance changes reported by the range finder;
e. a second means to adjust one of (i) the other of the primary and secondary optic; (ii)the telescope; or (iii) the first means, along the optical axis relatively infrequently and for relatively long distance changes compared to the small distance changes of the first means;
f. to promote maintenance of focus for both (i) relatively high frequency, small distance senses changes in platform-to-target distances and (ii) relatively low frequency, larger distance changes in platform-to-target distances.

2. The apparatus of claim 1 wherein the primary optic comprises a lens or mirror, the secondary optic comprises a lens or mirror.

3. The apparatus of claim 1 wherein the vehicle is a military vehicle.

4. The apparatus of claim 1 wherein the range finder comprises a laser range finder.

5. The apparatus of claim 1 wherein the first means comprises a linear actuator having a range of movement of mm or sub-mm at a rate of 10-100 hz.

6. The apparatus of claim 1 wherein the second means comprises a linear actuator having a range of movement of mm or above at a rate of above 10 hz.

7. The apparatus of claim 1 further comprising a processor operably connectable to:
a. the range finder;
b. the first means;
c. the second means;
d. to determine when, which, and how much movement for either of the first and second means.

8. The apparatus of claim 7 further comprising an output from the processor to a focus control of the optical detector to inform the focus control of any actuation of the first or second means.

9. The apparatus of claim 8 in combination with an autofocus optical sensing system.

10. The system of claim 9 in combination with a vehicle.

11. A method of promoting effective focus of a downward looking optical detection system comprising:
a. using a fast, small range of travel actuator to adjust optical component to target distance for higher frequency, relatively small sensed distance changes;
b. using a slower but longer range of travel actuator to adjust optical component to target distance for lower frequency, relatively larger sensed distance changes.

12. The method of claim 11 wherein the fast, small range of travel comprising on the order of:
a. mm or sub-mm; and
b. 10-100 hz.

13. The method of claim 11 wherein the slower but longer range of travel comprises on the order of:
a. mm or greater; and
b. greater than 10 hz.

14. The method of claim 11 wherein the fast actuator is operably connected to a primary optic of the optical detection system.

15. The method of claim 11 wherein the slow actuator is operably connected to one of:
a. a secondary optic of the optical detection system;
b. the optical detection system;
c. the fast actuator.

16. An apparatus for downward looking optical detection from a vehicle comprising:
a. a mounting platform adapted for mounting to the vehicle;
b. a range finder on the platform for measuring platform to target distance;
c. an optical detection assembly on the platform;
d. a first linear actuator operably connected to a primary optic of the optical detection assembly for relatively small linear adjustments;
e. a second linear actuator operably connected to one of (i) another optic of the optical detection assembly, (ii) the optical detection assembly, or (iii) the first linear actuator for relatively larger linear adjustments;
f. a controller operably connected to the range finder and the first and second actuators and programmed to determine which of the first and second linear actuators should be actuated in response to platform to target distance from the range finder.

17. The apparatus of claim 16 further comprising the controller having access to a database of PSD data for different terrains which can be used to inform the controller of real-time operation of the first and second linear actuators.

18. The apparatus of claim 17 wherein the database of PSD data for different terrains is from one or more of:
a. prior testing at a remote site;
b. prior testing of the present site;
c. published information.

19. The apparatus of claim 16 further comprising the controller dynamically changing the range of movement of at least one of the first and second linear actuators based on a running history of sensed terrain.

20. The apparatus of claim 19 wherein the dynamic changing comprises reducing the range of movement of one or more of the first and second linear actuators if running history indicates possible while retaining effective focusing for detection.
